(19) United States
(12) Patent Application Publication
(10) Pub. No.: US 2008/0006502 A1
(43) Pub. Date: Jan. 10, 2008

(54) Clutch arrangement for the drive train of a vehicle

(75) Inventor: Jorg Sudau, Niederwerrn (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/821,890

(22) Filed: Jun. 26, 2007

(30) Foreign Application Priority Data
Jul. 5, 2006 (DE) 10 2006 031 036.5

(51) Int. Cl. F16F 15/10

(52) U.S. Cl. 192/70.17

(57) ABSTRACT

A clutch arrangement for a drive train of a motor vehicle includes a housing which can be filled with liquid; a first friction element carrier which can be connected to a drive component via a first path of torque transmission and carrying a first group of friction elements for rotation in common around an axis of rotation; a second friction element carrier which can be connected to a takeoff component via a second path of torque transmission and carrying a second group of friction elements for rotation in common around the axis of rotation; and a pressure exerting arrangement for bringing the friction elements of the second group into frictional engagement with the friction elements of the first group. A first torsional vibration damper arrangement is located in the first path of torque transmission, and a second torsional vibration damper arrangement is located in the second path of torque transmission.

### BACKGROUND OF THE INVENTION

1. Field of the Invention

The present invention pertains to a clutch arrangement for the drive train of a vehicle comprising a housing, which is or can be filled with fluid; a first group of friction elements, which is or can be connected to a drive component such as a crankshaft of an internal combustion engine for rotation in common around an axis of rotation by way of a first friction element carrier; and a second group of friction elements, which is or can be connected to a takeoff component such as a gearbox input shaft by way of a second friction element carrier. The friction elements of the first friction element group and the friction elements of the second friction element group can be brought into frictional engagement with each other by a pressure-exerting arrangement so that, in this way, torque can be transmitted by way of the clutch arrangement.

2. Description of the Related Art

A clutch arrangement of this type is known from U.S. Pat. No. 7,017,724, in which the second friction element carrier is connected to the takeoff component by way of a torsional vibration damper arrangement, especially a torsional vibration damper arrangement with a two-stage design. In this way, it becomes possible to damp the vibrational excitations which can be expected to occur in the drive train.

### SUMMARY OF THE INVENTION

An object of the present invention is to provide a clutch arrangement for the drive train of a vehicle by means of which improved vibration damping behavior can be achieved.

According to the invention, the clutch arrangement includes a first torsional vibration damper arrangement in the path of torque transmission between the first friction element carrier and the drive component to be connected to it, and a second torsional vibration damper arrangement in the path of torque transmission between the second friction element carrier and the takeoff component to be connected to it.

In the inventive design, therefore, two torsional vibration damper arrangements are provided, one in front of the two groups of friction elements and one behind the two groups of friction elements. This has the result that, when these two torsional vibration damper arrangements are in the torque-transmitting state, they are acting in series, which leads to optimized vibration damping and/or vibration isolation behavior. In the disengaged state of the clutch arrangement, i.e., in a state in which essentially no torque is being transmitted via the friction elements, the system areas of the clutch arrangement connected to the output area of the first torsional vibration damper arrangement, essentially therefore the first friction carrier and the friction elements of the first group mounted nonrotatably thereon, act as a vibration-damping mass, which is advantageous especially with respect to the damping of resonance vibrations when the engine is being started, i.e., when the rpm's are increasing into the range of the idling speed.

Each of the torsional vibration damper arrangements can have an input area and an output area, which is connected for the transmission of torque to the input area by way of a damping element arrangement, such as several damping springs.

In an especially advantageous embodiment, the second torsional vibration damper arrangement is installed inside the housing, the input area of the second torsional vibration damper arrangement includes the second friction element carrier or can be connected to it, and the output area of the second torsional vibration damper arrangement includes a hub for establishing a connection with the takeoff component or is connected to that component. In this way, it is ensured that, through the installation of the second torsional vibration damper arrangement inside the housing, this arrangement is also located in the fluid which fills the housing. Thus lubrication is present for the components which move with respect to each other, and energy can also be dissipated by the movement of the fluid.

Under another especially advantageous aspect, the damping element arrangement of the first torsional vibration damper arrangement can be located inside the housing. Through the installation of the first torsional vibration damper arrangement inside the housing as well, the same effect can be achieved as previously described with respect to the second torsional vibration damper arrangement.

To achieve the simplest possible design, the housing can form essentially the input area of the first torsional vibration damper arrangement, and the first friction element carrier can be mounted in the housing with freedom to rotate around the axis of rotation with respect to the housing.

The output area of the first torsional vibration damper arrangement can include or be connected to the first friction element carrier.

In the case of the previously described embodiment, therefore, when rotational vibrations occur, the first friction element carrier moves relative to the housing. If, furthermore, the pressure-exerting arrangement includes a pressure element which is mounted with freedom to shift in the housing in the direction parallel to the axis of rotation and which can rotate along with the housing around the axis of rotation, it is especially advantageous for this pressure element to act on the friction elements of the first friction element group and on the friction elements of the second friction element group by way of a rotational disconnect bearing. That is, when torsional vibrations occur in the engaged state of a clutch arrangement of this type, the two groups of friction elements and the two friction element carriers move in the circumferential direction relative to the housing and therefore also with respect to the pressure element, which rotates along with the housing. Because of the presence of a rotational disconnect function between the pressure element and the friction elements, the introduction of a force which opposes this relative circumferential movement is reduced as much as possible.

In an alternative design, the damping element arrangement of the first torsional vibration damper arrangement is installed outside the housing. The advantage of this variant is that it becomes possible to assemble the two system areas as modules, the first system area including the clutch arrangement assemblies located inside the housing, including especially the second torsional vibration damper arrangement, and the second system area including the first torsional vibration damper arrangement, located externally relative to the housing. In addition, the mass located between the two torsional vibration damper arrangements and/or the mass moment of inertia generated by that mass is comparatively large in the rotating state. If the pressure element is able to rotate with the housing, furthermore, the previously mentioned relative movement between the pressure element and the friction elements can be avoided.

For example, the input area of the first torsional vibration damper arrangement can be connected to the drive component by means of a disk-like connecting arrangement. The output area of the first torsional vibration damper arrangement can include the housing or be connected to it.

Because, in this embodiment, the axial force necessarily arising because of the introduction of fluid under pressure into the housing is possibly absorbed or is possibly to be absorbed by the first torsional vibration damper arrangement, a pretensioning element acting essentially in the axial direction may be provided between the input area of the first torsional vibration damper arrangement and the output area of the first torsional vibration damper arrangement and/or the housing. It is possible in this way to relieve the load acting in the axial direction on the first torsional vibration damper arrangement.

In this design variant, the housing can form the first friction element carrier. The previously discussed aspect of the modular assembly of system areas can thus be exploited even more by designing the first torsional vibration damper arrangement as a dual-mass flywheel with a primary side to be connected to the drive component and a secondary side connected to the housing. Both the dual-mass flywheel and the remaining system areas of the clutch arrangement can then be essentially of conventional design.

An additional way of relieving the load exerted by forces acting on a torsional vibration damper arrangement, especially on an arrangement located outside the housing, is to provide the housing with a housing hub, which is or can be supported axially and/or radially with respect to the drive component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a longitudinal cross section through a clutch arrangement;

FIG. 2 shows a longitudinal cross section through an alternative embodiment of a clutch arrangement; and

FIG. 3 shows a longitudinal cross section through another alternative embodiment of a clutch arrangement.

### DETAILED DESCRIPTION OF THE PRESENTLY PREFERRED EMBODIMENTS

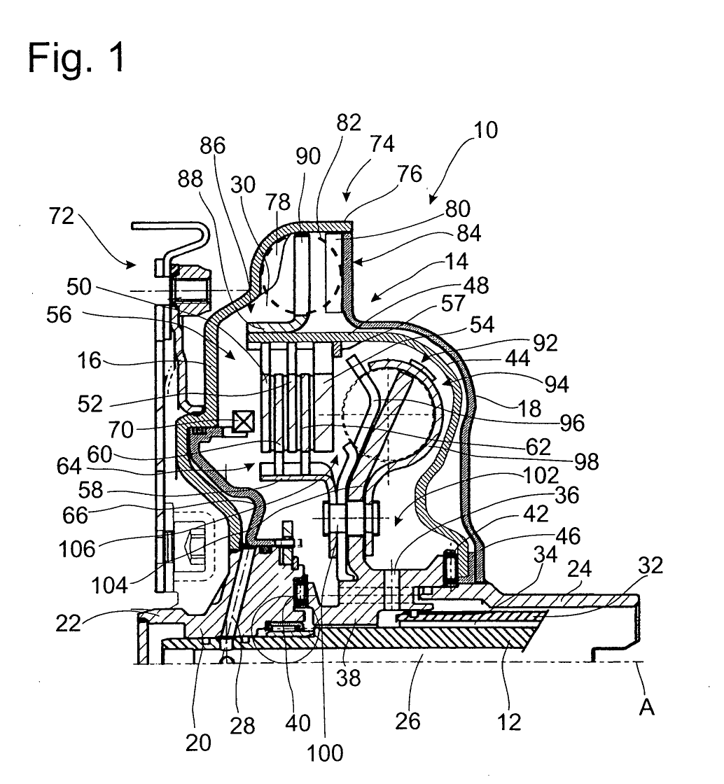

The clutch arrangement 10 shown in FIG. 1 serves to transmit torque between a drive component, such as the crankshaft (not shown) of an internal combustion engine, and a takeoff component, such as a gearbox input shaft 12. The clutch arrangement 10 is designed as a wet-running clutch arrangement and includes a housing 14, which consists essentially of two housing shells 16 and 18. The housing shell 16 positioned on the drive side is permanently connected radially on the inside to a housing hub 20 by means of welding, for example. An axial shoulder 22 of this housing hub 20 can be or is axially and/or radially supported in a corresponding recess in a crankshaft or the like by means of, for example, a pilot bearing. In the radially outer area, the two housing shells 16, 18 are also permanently connected to each other by means of welds, for example, and the takeoff-side housing shell 18 is permanently connected by welding, for example, in the radially inner area to a drive extension 24 designed as a hollow shaft, which drives a pump installed in a gearbox, by which fluid, such as transmission oil, is introduced through a central opening 26 in the gearbox input shaft 12 and one or more channels 28 in the housing hub 20 into an interior space 30 of the housing 14. Fluid is also introduced into the interior space 30 or drawn out of that space through an intermediate space 34 formed between the gearbox input shaft 12 and a support shaft 32 and via one or more channels 36 in a takeoff hub 38. This takeoff hub 38 is connected nonrotatably to the gearbox input shaft 12 by means of appropriate sets of teeth. The takeoff hub 38, furthermore, is supported axially by bearings 40, 42 with respect to the housing 14, especially with respect to the housing hub 20, on one side and with respect to the housing shell 18 on the other side. The takeoff hub 38 is not supported directly on the housing shell 18 by the bearing 42 but rather indirectly by way of the radially inner terminal area of a first friction element carrier 44, to be explained further below, which in turn is supported axially with respect to the housing shell 18 and radially with respect to the drive extension 24 by way of a rotational disconnect bearing 46, designed, for example as a plain bearing ring.

Friction elements 50, 52, 54 of a first friction element group 56 are connected for rotation in common around an axis of rotation A to a radially outer, essentially cylindrical section 48 of a first friction element carrier 44 by mutually engaging sets of teeth. Through the special design of these sets of teeth, however, the friction elements 50, 52, 54, are able to move in the axial direction with respect to the first friction element carrier 44. The friction element 54 located the farthest to the right in FIG. 1, i.e., on the takeoff-side, is supported axially with respect to the friction element carrier 44 by means of a locking ring 57 or the like.

A second friction element carrier 58 surrounded radially by the first friction element carrier 44 carries friction elements 60, 62 of a second friction element group 64. These friction elements 60, 62 engage between the friction elements 50, 52, 54 of the first group 56 and can be brought into frictional engagement with them. For this purpose, a pressure element 66 formed as an annular piston is provided, which is mounted with freedom of axial movement with respect to the housing 14 but rotates around the axis of rotation A together with the housing 14. It can be seen that, by increasing the fluid pressure in the area of the channels 28, the fluid pressure in the space formed between the pressure element 66 and the first housing shell 16 also increases correspondingly, and thus the pressure element 66 is moved toward the two groups 56, 64 of friction elements. The pressure element 66 exerts force on the friction element 50 by way of a rotational disconnect bearing 70, such as a rolling element bearing or a plain bearing, and thus presses the various friction elements 50, 52, 54; 60, 62 against each other for frictional interaction, the axial support being provided by the locking ring 57.

A first torsional vibration damper arrangement 74 is provided in the path of torque transmission between a clutch arrangement 72 attached externally to a housing shell 16 and to be permanently connected to the drive component, i.e., a crankshaft, for example, and the first friction element carrier 44. This first damper arrangement comprises, as its input area 76, essentially the radially outer areas of the two housing shells 16, 18, on which support sections 78, 80 for the damping elements 82 of a damping element arrangement 84 of this first torsional vibration damper arrangement 74 are formed. On the outside surface of the first friction element carrier 44, a driver element 88 is fastened by welding, for example. This element acts as the output area 86, and its radially outward-projecting arm sections 90 engage between the support areas 78, 80 of the input area 76 and circumferentially between individual damping elements 82, i.e., for example, coil springs or groups of coil springs. The damping elements 82 are thus supported in the circumferential direction against the support areas 78, 80 and the arms 90 and, because of their compressibility in the circumferential direction, allow a certain amount of relative rotational movement between the input area 76 and the output area 86. This means that the housing 14 can move relative to the first friction element carrier 44 as the damping elements 82 are being compressed. When the clutch arrangement 10 is in the engaged state and torsional vibrations occur which bring about relative circumferential movement between the housing 14 and the friction element carrier 44 and therefore also the friction element 50, relative circumferential movement between this friction element 50 and the pressure element 66 also occurs, but because of the presence of the rotational disconnect bearing 70, this is easily possible.

A second torsional vibration damper arrangement 92 is located in the path of torque transmission between the second friction element carrier 58 and the takeoff hub 38. An input area 94 of this damper arrangement includes two cover disk elements 96, 98, which, in their radially inner area, are permanently connected by rivets 100 or the like to each other and also to the second friction element carrier 58. Between the two cover disk elements 96, 98 there is a central disk element 104, which serves essentially as the output area 102. Support areas are also provided on the central disk element 104 and on the cover disk elements 96, 98. The damping elements 107 of a damping element arrangement 106 of the second torsional vibration damper arrangement 92 are supported circumferentially against these support areas. These elements 107 are preferably formed as coil springs. Relative circumferential movement of the second friction element carrier 58 with respect to the takeoff hub 38 and therefore also with respect to the gearbox input shaft 12 is therefore made possible under compression of the damping elements 107 of the damping element arrangement 106. During this relative circumferential movement, the rivets 100 move in elongated circumferential openings in the central disk element 104. In this way, the second torsional vibration damper arrangement 92 is provided simultaneously with a rotational distance-limiting function. It should also be pointed out that, of course, the central disk element 104, as illustrated here, can be designed as an integral part of the takeoff hub 38 or can be connected to it permanently by welding or the like. It can also be seen that the radially inner terminal area of the cover disk element 96, for example, is supported on the takeoff hub 38 and thus supports the input area 94 of the second torsional vibration damper arrangement 92 radially with respect to the output area 102.

By incorporating two torsional vibration damper arrangements 74 and 92 into the path of torque transmission, namely, a first arrangement in front of the groups 56, 64 of friction elements and as second one behind the groups 56, 64 of friction elements, very good vibration-isolating behavior is achieved in a drive train. Because the first torsional vibration damper arrangement 74 is active in all cases, even during the starting phase of an internal combustion engine while the clutch arrangement is disengaged, i.e., when the groups 56, 64 of friction elements are essentially disconnected frictionally from each other, the functionality of a dual-mass flywheel can be ensured, where a comparatively large mass is present in the output area because of the connection between the output area 86 of the first torsional vibration damper arrangement 74 and the first friction element carrier 44 or the first group 56 of friction elements. An advantage of incorporating both torsional vibration damper arrangements 74, 92 into the internal volume of the housing 14 is that both torsional vibration damper arrangements are wet-running and therefore acquire additional vibration-damping functionality and are also effectively lubricated at the same time. It is also ensured that the pump installed in the gearbox is driven directly by the drive extension 24 and the housing 14. The axial forces which arise as a result of the introduction of fluid under pressure into the interior space 30 can be absorbed completely inside the housing; that is, these forces impose no load on either of the two torsional vibration damper arrangements 74, 92.

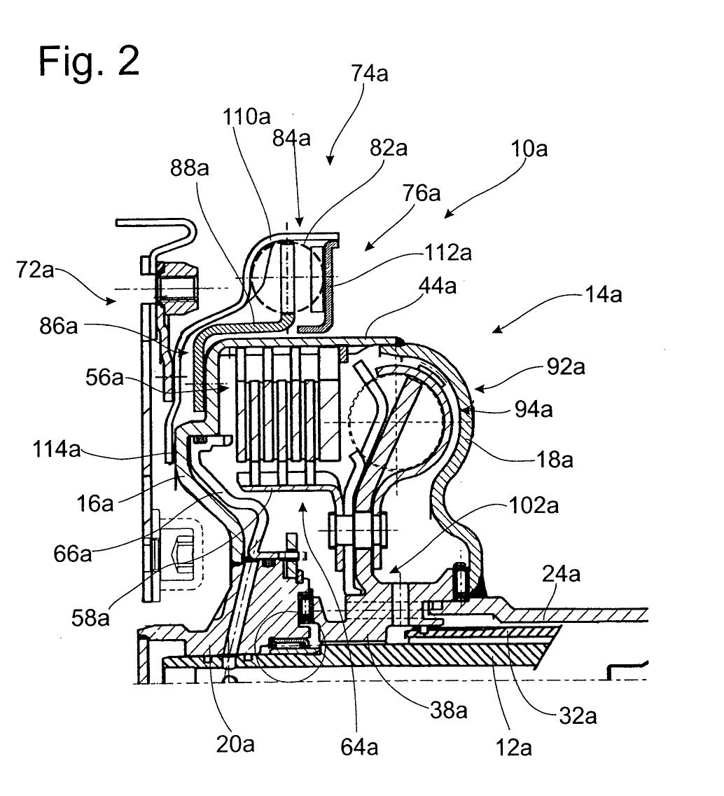

An alternative embodiment of a clutch arrangement with two torsional vibration damper arrangements is shown in FIG. 2. Components which are the same as those previously described with respect to design and/or function are designated by the same reference numbers, except that an “a” has been added to them. It should be pointed out that, in the following, only the differences between this embodiment and the previously described first embodiment will be discussed.

Whereas, in the embodiment shown in FIG. 2, the structure of the second torsional vibration damper arrangement 92a in conjunction with the second friction element carrier 58a corresponds primarily to the previously described arrangement, it can be seen that the first friction element carrier 44a now forms an integral part of the housing shell 16a, i.e., of the housing 14a. In the radially outer and approximately cylindrical area, this housing shell 16 therefore has a set of teeth, with which the first group 56a of friction elements engages. Because relative circumferential movement between the first friction element carrier 44a and the housing 14a and thus also the pressure element 66a will therefore not occur in this embodiment, the pressure element 66a can actuate the two groups 56a, 64a of the friction elements directly, without the intermediate presence of a rotational disconnect bearing.

The first torsional vibration damper arrangement 74a is now located outside the housing 14a. Two cover disk elements 110a, 112a, made out of sheet metal, for example, form essentially the input area 76a of the first torsional vibration damper arrangement 74a, where the cover disk element 110a positioned on the drive side extends radially inward a comparatively long way, part of it radially overlapping the first housing shell 16a. The connecting arrangement 72a, by means of which the nonrotatable connection to the crankshaft or other drive component is accomplished, is permanently connected to this cover disk element 110a. The driver element 88a, which forms essentially the output area 86a, is permanently connected to the outside surface of the housing 14a, namely, of the first housing shell 16a, by means of welding, for example, and its radially outer area engages between the two cover disk elements 110a, 112a to produce in this way the interaction with the damping elements 82a of the damping element arrangement 84a as is familiar from these types of torsional vibration dampers.

So that the torsional vibration damper arrangement 74a can be relieved of the axial thrust forces which occur upon introduction of pressurized fluid into the housing 14a in this embodiment, a pretensioning element 114a, designed as a plate spring, for example, acts between the radially inner end area of the cover disk element 110a and the first housing shell 16a. As a result of this pretensioning element 114a, a force acts between the input area 76a and the output area 86a of the first torsional vibration damper arrangement 74a to ensure that, even when axial thrust forces occur, the two areas will always remain suitably positioned with respect to each other.

Two serially acting torsional vibration damper arrangements 74a and 92a are also present in the design variant shown in FIG. 2. Because the first torsional vibration damper arrangement 74a is not integrated into the housing 14a, a modular type of system is created, so that different modules can be connected together, which allows the overall system to be adapted to different drive trains.

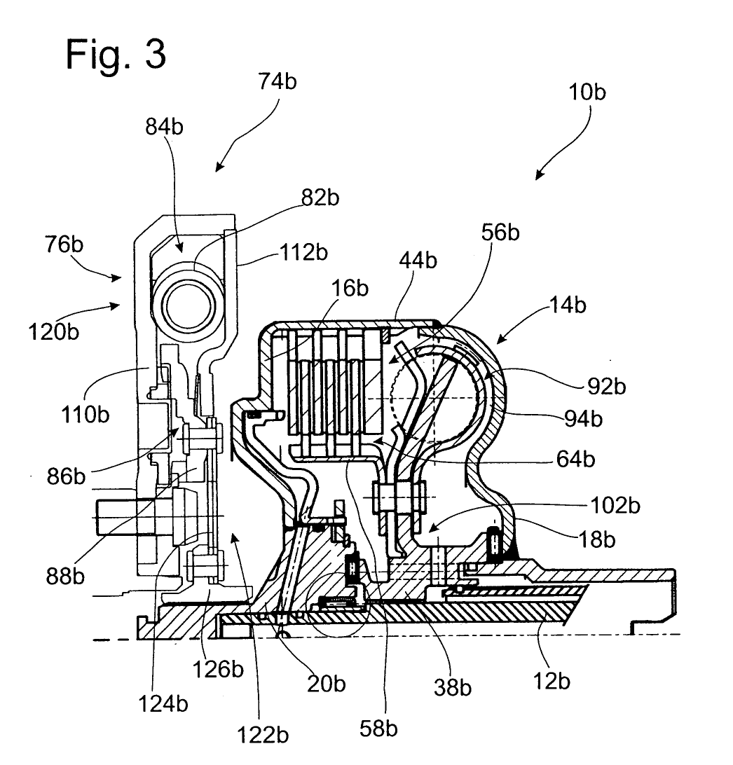

This adaptability, i.e., the modular character of the design, is illustrated again by the additional embodiment shown in FIG. 3. Here components which correspond to previously described components with respect to design and/or function have been designated by the same reference numbers plus the letter “b”. It can be seen here that the modular section including the housing 14b and the system areas installed in it corresponds to what was shown in FIG. 2, whereas the first torsional vibration damper arrangement 74b is designed as an essentially conventional dual-mass flywheel. This includes two cover disk elements 110b, 112b as the input area 86b, i.e., as the primary side 120b. A central disk element or driver element 88b, providing essentially the output area 86b or secondary side 122b, fits between these two cover disk elements. In the radially outer area, the interaction, known in itself, with the damping elements 82b of the damping element arrangement 84b is present. The driver element 88b is connected for rotation in common to the housing hub 20b of the hub 14b by means of, for example, leaf spring elements 124b and a hub area 126b, which is connected to the radially inside ends of the springs. Sets of mutually engaging teeth are provided on the housing hub 20b and the hub area 126b.

In all of the embodiments of an inventive clutch arrangement described above, the advantage is offered that the second torsional vibration damper arrangement is located inside the fluid-filled interior of the housing and thus can operate as a wet-running damper arrangement. If the first torsional vibration damper arrangement is integrated into the housing or if it is installed outside the housing but is of suitable design, it, too can have wet-running functionality. Because the output area of the first torsional vibration damper arrangement in the inventive design is connected to the first group of friction elements, there also exists the possibility—especially during the starting phase of an internal combustion engine as its rpm's increase to idling speed—of introducing an additional fluid damping function to prevent the excitation of resonance vibrations before idling speed is reached. For this purpose, an additional damping function can be provided, especially during the starting phase, by controlling the clutch arrangement 10 in such a way that the two groups of friction elements are brought into frictional engagement with each other to increase the output-side mass of the first torsional vibration damper arrangement and to allow a slippage torque.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch arrangement for a drive train of a motor vehicle, the arrangement comprising:
a housing which can be filled with liquid;
a first friction element carrier which can be connected to a drive component via a first path of torque transmission and carrying a first group of friction elements for rotation in common around an axis of rotation;
a second friction element carrier which can be connected to a takeoff component via a second path of torque transmission and carrying a second group of friction elements for rotation in common around said axis of rotation;
a pressure exerting arrangement for bringing the friction elements of the second group into frictional engagement with the friction elements of the first group;
a first torsional vibration damper arrangement in the first path of torque transmission; and
a second torsional vibration damper arrangement in the second path of torque transmission.

2. The clutch arrangement of claim 1 wherein each of said first and second torsional vibration damper arrangements comprises:
an input area;
an output area; and
a damping element arrangement for transmitting torque from the input area to the output area.

3. The clutch arrangement of claim 1 wherein the second torsional vibration damper arrangement is located inside the housing, the input area of the second torsional vibration damper arrangement being fixed to the second friction element carrier, the output area of the second torsional vibration damper arrangement comprising a hub which can be connected to the takeoff component.

4. The clutch arrangement of claim 2 wherein the damping element arrangement of the first torsional vibration damper arrangement is located inside the housing.

5. The clutch arrangement of claim 4 forms the input area of the first torsional vibration damper arrangement.

6. The clutch arrangement of claim 4 wherein the first friction element carrier is mounted in the housing with freedom to rotate around the axis of rotation relative to the housing.

7. The clutch arrangement of claim 4 wherein the output area of the first torsional vibration damper arrangement is connected to the first friction element carrier.

8. The clutch arrangement of claim 4 wherein the pressure exerting arrangement comprises a pressure element mounted in the housing, the pressure element being movable parallel to the axis of rotation and rotatable about the axis of rotation in common with the housing, the clutch arrangement further comprising a rotational disconnect bearing between the pressure element and the friction elements of the first friction element group.

9. The clutch arrangement of claim 2 wherein the damping element arrangement of the first torsional vibration damper arrangement is located outside the housing.

10. The clutch arrangement of claim 9 further comprising a disk-like connecting arrangement for connecting the input area of the first torsional vibration damper arrangement to the drive component.

11. The clutch arrangement of claim 8 wherein the output area of the first torsional vibration damper arrangement is fixed to the housing.

12. The clutch arrangement of claim 9 further comprising an axially acting pretensioning element provided between the input area of the first torsional vibration damper arrangement and at least one of output area of the first torsional vibration damper arrangement and the housing.

13. The clutch arrangement of claim 9 wherein the housing forms the first friction element carrier.

14. The clutch arrangement of claim 9 wherein the first torsional vibration damper arrangement comprises a dual mass flywheel having a primary side which can be connected to the drive component and a secondary side connected to the housing.

15. The clutch arrangement of claim 1 wherein the housing comprises a housing hub which can be supported radially with respect to the drive component.

16. The clutch arrangement of claim 1 wherein the housing comprises a housing hub which can be supported axially with respect to the drive component.
